(19) United States
(12) Patent Application Publication
(10) Pub. No.: US 2026/0252378 A1
(43) Pub. Date: Aug. 27, 2026

(54) SYSTEMS, APPARATUSES, METHODS, AND COMPUTER PROGRAM PRODUCTS FOR ARTIFICIAL INTELLIGENCE-DRIVEN INTERACTIVE TASK EXECUTION

(71) Applicant: Go Now Solutions LLC, Hawkinsville, GA (US)

(72) Inventor: Al Vincent Arrington, Hawkinsville, GA (US)

(21) Appl. No.: 19/548,574

(22) Filed: Feb. 24, 2026

Related U.S. Application Data
(60) Provisional application No. 63/763,140, filed on Feb. 25, 2025.

(51) Int. Cl. G06F 9/48

(52) U.S. Cl. CPC G06F 9/4843

(57) ABSTRACT

Embodiments of the present disclosure provides systems, apparatuses, methods, and computer program products for AI-driven interactive task execution. A system may be configured to receive, from a user device, a task guidance request that identifies a task. The system may analyze the task guidance request to identify a task context comprising a task category, an execution environment, and a user skill level. The system may decompose the task into an ordered sequence of execution steps using a dynamic task decomposition algorithm that adapts step granularity based at least in part on the user skill level. The system may generate, for each execution step, instructional data comprising one or more actions. The system may generate a customized task execution plan by synthesizing a personalized instructional video sequence based on the ordered sequence of execution steps. The system may cause performance of the task based on the customized task execution plan.

### CROSS-REFERENCE TO RELATED APPLICATIONS

This application claims priority to U.S. Provisional Patent Application No. 63/763,140, filed on Feb. 25, 2025, which is incorporated herein by reference in its entirety.

### TECHNOLOGICAL FIELD

The present disclosure relates to task execution; and more particularly to systems, apparatuses, methods, and computer-readable media for artificial intelligence (AI)-driven interactive task execution.

### BACKGROUND

Various embodiments of the present disclosure address technical challenges related to task execution. Through applied effort, ingenuity, and innovation, Applicant has solved problems related to task execution by developing solutions embodied in the present disclosure, which are described in detail below.

### BRIEF SUMMARY

Various embodiments of the present disclosure provide methods, apparatus, systems, computing devices, computing entities, and/or the like for artificial intelligence (AI)-driven interactive task execution.

According to an aspect of the present disclosure, a system is provided. In some embodiments, the comprises memory and one or more processors communicatively coupled to the memory, the one or more processors configured to receive, from a user device associated with a user, a task guidance request that identifies a task, wherein the task guidance request comprises one or more of natural language text, an image, or a video; analyze the task guidance request to identify a task context comprising a task category, an execution environment, and a user skill level; decompose the task into an ordered sequence of execution steps using a dynamic task decomposition algorithm that adapts step granularity based at least in part on the user skill level; generate, for each execution step, instructional data comprising one or more actions; generate a customized task execution plan by synthesizing a personalized instructional video sequence based on the ordered sequence of execution steps, wherein the personalized instructional video sequence depicts the ordered sequence of execution steps, and wherein synthesizing the personalized instructional video sequence comprises dynamically generating the personalized instructional video sequence; and cause performance of the task based on the customized task execution plan.

In some embodiments, analyzing the task guidance request comprises fusing multimodal input data associated with the task guidance request into a unified task-state representation that informs subsequent instructional generation.

In some embodiments, the dynamic task decomposition algorithm is configured to adjust, based on prior task performance data associated with the user, one or more of (i) execution steps count, (ii) execution steps complexity, or (iii) execution steps sequence.

In some embodiments, synthesizing the personalized instructional video sequence comprises generating synthetic visual representations of task execution using an artificial intelligence video synthesis engine.

In some embodiments, the artificial intelligence video synthesis engine implements one or more of motion modeling, object interaction simulation, or procedural visualization to depict task execution.

In some embodiments, the personalized instructional video sequence comprises segmented steps that are individually pausable, replayable, or recordable based on user interaction during task execution.

In some embodiments, the one or more processors are further configured to receive progress data from the user device during task execution; and modify subsequent instructional output in real time based on one or more of detected deviations, detected errors, or incomplete execution of one or more execution steps.

In some embodiments, the progress data comprises user-recorded video of task execution, and wherein the one or more processors are further configured to analyze the user-recorded video to identify errors relative to the ordered sequence of execution steps.

In some embodiments, the system further comprises an augmented reality guidance module configured to overlay visual execution cues onto a live camera view of the user device corresponding to at least on execution step.

In some embodiments, the augmented reality guidance module dynamically aligns the visual execution cues based on spatial features detected in the execution environment.

In some embodiments, the instructional data further comprises dynamically generated tool and material recommendations based on one or more of the task context or execution environment.

In some embodiments, the system further comprises a skill progression engine configured to track user task history; and adjust future instructional generation based on accumulated skill data.

In some embodiments, the skill progression engine is configured to identify transferable skills across one or more task categories; and modify instructional complexity based on the transferable skills.

In some embodiments, the instructional data further comprises safety-critical steps that are emphasized, reordered, or locked against skipping based on risk assessment associated with the task.

In some embodiments, the task comprises one of a home repair, appliance repair, automotive maintenance, craft assembly, accessibility assistance, or vocational training.

In some embodiments, the personalized instructional video sequence is generated uniquely for each user request and not reusable as a generic tutorial for multiple users.

In some embodiments, the personalized instructional video sequence is optimized for task completion validation.

According to an aspect of the present disclosure, a computer-implemented method is provided. The computer-implemented method is executable using any of a myriad of computing device(s) and/or combinations of hardware, software, and/or firmware. In some example embodiments, the method includes receiving, by one or more processors and from a user device, a task guidance request that identifies a task, wherein the task guidance request comprises one or more of natural language text, an image, or a video; analyzing, by the one or more processors, the task guidance request to identify a task context comprising one or more of a task category, an execution environment, and a user skill level, decomposing, by the one or more processors, the task into an ordered sequence of execution steps using a dynamic task decomposition algorithm that adapts step granularity based at least in part on the user skill level; generating, by the one or more processors, for each execution step, instructional data comprising one or more actions; generating, by the one or more processors, a customized task execution plan by synthesizing a personalized instructional video sequence based on the ordered sequence of execution steps, wherein the personalized instructional video sequence depicts the ordered sequence of execution steps, and wherein synthesizing the personalized instructional video sequence comprises dynamically generating the personalized instructional video sequence; and causing, by the one or more processors, performance of the task based on the customized task execution plan.

In accordance with another aspect of the present disclosure, a computer program product is provided. The computer program product in some embodiments includes at least one non-transitory computer-readable storage medium having computer coded instructions configured to, when executed by at least one processor receive, from a user device, a task guidance request that identifies a task, wherein the task guidance request comprises one or more of natural language text, an image, or a video; analyze the task guidance request to identify a task context comprising one or more of a task category, an execution environment, and a user skill level, decompose the task into an ordered sequence of execution steps using a dynamic task decomposition algorithm that adapts step granularity based at least in part on the user skill level; generate, for each execution step, instructional data comprising one or more actions; generate a customized task execution plan by synthesizing a personalized instructional video sequence based on the ordered sequence of execution steps, wherein the personalized instructional video sequence depicts the ordered sequence of execution steps, and wherein synthesizing the personalized instructional video sequence comprises dynamically generating the personalized instructional video sequence; and cause performance of the task based on the customized task execution plan.

### BRIEF DESCRIPTION OF FIGURES

Reference will now be made to the accompanying drawings, which are not necessarily drawn to scale, and wherein:

FIG. 1 illustrates a block diagram of an example system environment within which at least some embodiments of the present disclosure may operate.

FIG. 2 illustrates a block diagram of an example apparatus in accordance with at least some embodiments of the present disclosure.

FIG. 3 illustrates a block diagram of an example client computing device in accordance with at least some embodiments of the present disclosure.

FIG. 4 illustrates an example flowchart diagram of an example intelligent task guidance process in accordance with at least some embodiments of the present disclosure.

FIG. 5 illustrates a flowchart diagram of an example AI-guided interactive task execution process in accordance with at least some embodiments of the present disclosure.

FIGS. 6-9D illustrate an operational example of intelligent task guidance process showing various stages thereof in accordance with at least some embodiments of the present disclosure.

FIG. 10 illustrates an operational example of measurement data acquisition technique in accordance with at least some embodiments of the present disclosure.

FIG. 11 illustrates an operational example of a fault detection technique in accordance with at least some embodiments of the present disclosure.

FIG. 12 illustrates an operational example of guided visual instructions in accordance with at least some embodiments of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### OVERVIEW AND TECHNICAL IMPROVEMENTS

Existing instructional resources for physical tasks rely on static, pre-recorded tutorials or written guides that are generic, non-interactive, and not tailored to a user's specific environment, tools, skill level, or task conditions. As a result, users frequently encounter errors, incomplete task execution, or reliance on professional assistance despite available instructional content.

The present disclosure addresses the aforementioned technical challenges by providing an AI task guidance system that generates personalized, step-by-step guidance for physical task execution. The system receives multimodal user input (such as text, images, video, and optional measurements), analyzes task context, and dynamically decomposes the task into ordered execution steps. Rather than retrieving pre-existing tutorials, the system generates instructional guidance specific to the user's task and environment. In certain embodiments, the system produces AI-generated instructional video representations to visually demonstrate task execution without reliance on pre-recorded human demonstrations.

Example embodiments involve dynamic task decomposition based on user input and skill level, personalized instruction generation specific to the identified task context, AI-generated instructional media created on demand, and/or real-time feedback during task execution This, in turn enables guided task completion rather than passive instruction consumption.

### DEFINITIONS

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

As used herein, the terms “data,” “content,” “information,” and similar terms may be used interchangeably to refer to data capable of being transmitted, received, or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, or the like.

As used herein, the term “circuitry” refers to particular hardware configured to perform the functions associated with the particular circuitry as described herein. In some embodiments, circuitry may be used as part of (a) hardware-only circuit implementations (e.g., implementations in analog circuitry or digital circuitry); (b) combinations of circuits and computer program product(s) comprising software or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. In some embodiments, “circuitry” may include processing circuitry, storage media, network interfaces, input/output devices, or the like. As a further example, as used herein, the term “circuitry” also includes an implementation comprising one or more processors or portion(s) thereof and accompanying software or firmware. As another example, the term “circuitry” as used herein also includes, for example, a baseband integrated circuit or applications processor integrated circuit for a mobile phone or a similar integrated circuit in a server, a cellular network device, other network device, or other computing device.

As used herein, a “computer-readable storage medium,” refers to a physical storage medium (e.g., volatile, or non-volatile memory device), and may be differentiated from a “computer-readable transmission medium,” which refers to an electromagnetic signal. A computer-readable storage medium may be a non-transitory medium.

As used herein, the terms “data structure,” “data object,” or “data set” refer interchangeably to data capable of being transmitted, received, or stored. For example, a predicted asset may be associated with one or more data elements or impacts in a computer-readable storage medium or computer-readable transmission medium, that represents content that is configured for use or display by one or more software applications, services, microservices, or the like.

The term “client computing device,” “client device,” “user device,” “client computing entity” and similar terms may be used interchangeably to refer to a computer comprising at least one processor and at least one memory. In some embodiments, the client computing device may further comprise one or more of: a display device for rendering one or more of a graphical user interface, a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client computing device” and the aforementioned similar terminology may refer to computer hardware or software that is configured to access a service or functionality offered by a system, for example, a service or functionality that is made available by a server. Such a server may be in a different location or another computing system, in which case the client computing device may access the server by way of a network. Client computing devices may include, without limitation, smart phones, tablet computers, kiosk, terminal, laptop computers, wearables, personal computers, enterprise computers, or the like. Client computing devices, as described herein, may communicate with or otherwise access a computing system, via one or more networks. In some embodiments, the at least one processor and the at least one memory need not be physically co-located with other elements of the client computing device (e.g., in a terminal environment, in which a display may be separated from a server-based processor or memory).

In some embodiments, a client computing device may be associated with a particular operator. In some embodiments, a client computing device may be a general purpose computing device having special purpose computer programming stored or executed thereon (e.g., a program, application, or web browser session running on a personal computer or smartphone). In some embodiments, a client computing device may be configured as a terminal or other remote viewing apparatus configured to display graphical user interfaces and associated information generated on a remote computing device. In some embodiments, a client computing device may be a special purpose computing device configured to perform the various functions described herein. Various embodiments of client computing devices may include, without limitation, smartphones, tablets, laptops, terminals, kiosks, personal computers, desktop computers, enterprise computers, or the like. Various embodiments of client computing devices may operate using different operating systems including, without limitation, IOS, ANDROID, WINDOWS, MACOS, LINUX, CHROME OS, or the like.

As used herein, the term “graphical user interface,” “user interface,” and similar terms may be used interchangeably to refer to any electronically renderable visual output producible for viewing by a user. A graphical user interface may include a representation of a software interface. For example, a graphical user interface may be the visual representation of a software such as a website, mobile application, desktop application, or the like, that may be used to generally interface with the software. By way of example, images, buttons, links, backgrounds, text fields, or the like, may be included within or make up a graphical user interface. In various examples, a graphical user interface may be configured for display on one or more screens (e.g., a screen of a mobile phone, a personal computer, or the like).

As used herein, the term “repository,” “database,” and similar terms may be used interchangeably to refer to a computing location associated with a system where data is stored, accessed, modified, and otherwise maintained by the system. A repository may be used to store data in association with a data storage protocol or a query language. In certain embodiments, a repository may embody a data storage device or devices, a separate database server or servers, or as a combination of data storage devices and separate database servers. Further, in some embodiments, a repository may be embodied as a distributed repository such that some of the stored data is stored centrally in a location within the repository and other data stored in a single remote location or a plurality of remote locations. Alternatively, in some embodiments, a repository may be distributed over a plurality of remote storage locations only such as in a cloud storage environment.

The terms “machine learning model,” “artificial intelligence model(s),” refer to computational systems that implement machine learning algorithms. The term “artificial intelligence” or “AI” refers to computer systems designed to perform tasks such, but not limited to reasoning, learning, problem-solving, and natural language understanding. The term “machine learning” refers to a subset of artificial intelligence including methods and algorithms that enable computer systems to learn patterns from data and make predictions or decisions without being explicitly programmed with rules for each specific scenario. Machine learning models may be computer-implemented algorithms that may learn from data stored in databases or datastores, with or without relying on rules-based programming.

### EXAMPLE SYSTEMS, APPARATUSES, AND METHODS

Various embodiments of the present disclosure may be implemented as systems, apparatuses, methods, computing devices, computing entities, and/or the like. Various embodiments of the present disclosure may take the form of an entirely hardware embodiment, an entirely computer program product embodiment, and/or an embodiment that comprises a combination of computer program products and hardware performing certain steps or operations.

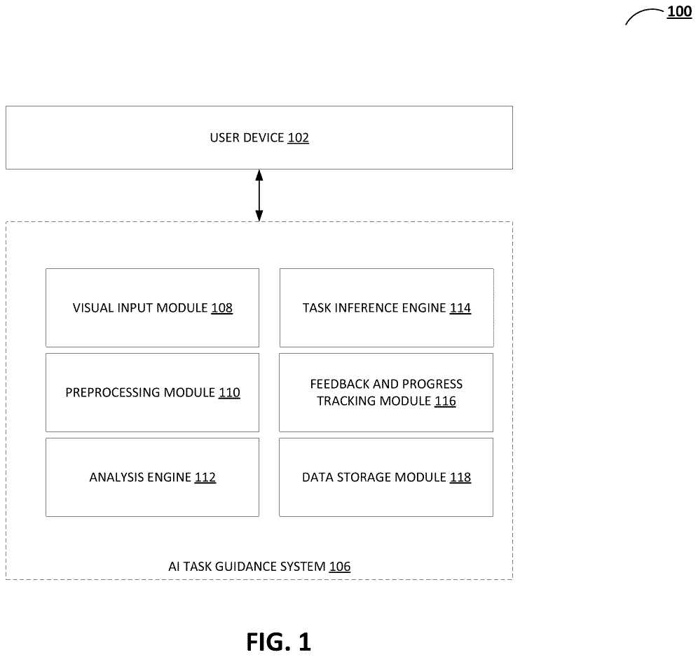

FIG. 1 illustrates a block diagram of a system that may be specially configured within which at least some embodiments of the present disclosure may operate. Specifically, FIG. 1 illustrates an example system environment 100 within which at least some embodiments of the present disclosure may operate. The depiction of the example system environment 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1 and the system environment 100 disclosed therein is merely presented to provide an example basis and context for the facilitation of some of the features, aspects, and uses of the methods, apparatuses, computer readable media, and computer program products disclosed and contemplated herein.

As illustrated, the system environment 100 includes an AI task guidance system 106 and one or more user devices 102. The example system environment 100 may be used in a plurality of domains and not limited to any specific application as disclosed herewith.

In some embodiments, the AI task guidance system 106 communicates with the user device 102 over one or more network(s). The communications network may be embodied in any of a myriad of network configurations. The communication networks may include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like). In some embodiments, the communications network may be a public network (e.g., the Internet). In some embodiments, the communications network may be a private network such as (e.g., an internal localized, or closed-off network between particular devices). In some embodiments, the communications network may be a hybrid network (e.g., a network enabling internal communications between particular connected devices and external communications with other devices). In some embodiments, the communications network may include one or more base station(s), relay(s), router(s), switch(es), cell tower(s), communications cable(s) and/or associated routing station(s), and/or the like. In some embodiments, the communications network may include one or more user controlled computing device(s) (e.g., a user owned router and/or modem) and/or one or more external utility devices (e.g., Internet service provider communication tower(s) and/or other device(s)).

The AI task guidance system 106 may be configured to receive requests such as task guidance requests from the user devices, process the requests to generate outputs such as task execution plans, and cause execution of the task execution plans. The AI task guidance system 106 may include a storage subsystem that may be configured to store input data (e.g., object data, image data, or the like), training data, and/or the like that may be used by the AI task guidance system 106 to perform analysis and/or training operations of the present disclosure. The storage subsystem may include one or more storage units, such as multiple distributed storage units that are connected through a computer network. In some embodiments, each storage unit may include one or more non-volatile storage or memory media such as, but not limited to, hard disks, ROM, PROM, MRAM, EPROM, RRAM, EEPROM, flash memory, Memory Sticks, MMCs, SD memory cards, and/or the like.

The AI task guidance system 106 may be specially configured to perform one or more steps/operations of one or more techniques described herein. The AI task guidance system 106 includes one or more computing device(s) and/or system(s) embodied in hardware, software, firmware, and/or a combination thereof, that perform intelligent task guidance process. For example, the AI task guidance system 106 may comprise or otherwise implemented as an interactive, multi-input task guidance platform configured to provide personalized, real-time instructional assistance to users, enabling AI-driven task execution. In some embodiments, the AI task guidance system 106 includes one or more specially configured application server(s), database server(s), end user device(s), cloud computing system(s), and/or the like. Additionally or alternatively, in some embodiments, the AI task guidance system 106 includes one or more client devices, user devices, and/or the like, that enables access to functionality provided via the AI task guidance system 106, for example via a web application, native application, and/or the like.

In some embodiments, the AI task guidance system 106 may be configured to operate on a user-operated mobile computing device, such as a smartphone or tablet, in communication with one or more remote computing systems.

The AI task guidance system 106 may be configured to receive visual input depicting a physical environment, analyze the visual input to identify conditions or objectives, determine one or more tasks responsive to the analysis, and generate adaptive, step-by-step task guidance for presentation to the user. Processing may be performed locally on the mobile device, remotely on one or more servers, or through a hybrid configuration.

In some embodiments the AI task guidance system 106 is specially configured to perform intelligent task guidance process utilizing one or more generative AI models. In some embodiments, the one or more generative AI models may include one or more large language models. In some embodiments, the AI task guidance system 106 and/or user device 102 communicate with one another to perform various steps/operations described herein. For example, in some embodiments, the AI task guidance system 106 and user device 102 may communicate to execute a task. In some embodiments, the AI task guidance system 106 and the user device 102 may communicate to facilitate control of the user device 102 or other devices based on an task execution plan generated via intelligent task guidance process, as described herein. For example, in some embodiments the AI task guidance system 106 and/or the user device 102 may communicate to configure one or more physical components based at least in part on the task execution plan. In some embodiments, the AI task guidance system 106 causes control of the user device 102 or other physical components based at least in part on task execution plan, for example via manual operation in response to data outputted by the AI task guidance system 106.

In some embodiments, the AI task guidance system 106 includes a visual input module 108 configured via hardware, software, firmware, and/or a combination thereof to perform one or more functions of the AI task guidance system 106. The visual input module enables acquisition of real-world environmental information directly from the user's surrounding. The visual input module may be configured to capture visual input that encompasses a target entity. Non-limiting examples of such visual input includes images and videos. The visual input module may be configured evaluate the captured visual input and upload the captured visual input for further processing. The visual input module may be configured to associated the captured visual input with an AI interactive session.

In some embodiments, the AI task guidance system 106 includes a preprocessing module 110 configured via hardware, software, firmware, and/or a combination thereof to perform one or more functions of the AI task guidance system 106. The preprocessing module may be configured to perform preprocessing operations configured to prepare the captured visual input for analysis. In some embodiments, the preprocessing operations include image normalization or enhancement, frame extraction from video input, noise reduction, and/or feature extraction. The image normalization operation may be configured to adjust, standardize, or transform the characteristics of an image to a desired or specified format or range. In some examples, image normalization may include resizing, cropping, or alignment. The frame extraction process may be configured to identify and extract one or more frames or still images from a captured video.

In some embodiments, the AI task guidance system 106 includes an analysis engine 112 configured via hardware, software, firmware, and/or a combination thereof to perform one or more functions of the AI task guidance system 106. The analysis engine may be configured to analyze captured visual input or preprocessed visual input to identify physical conditions, objects, material, components, or environmental characteristics. The analysis engine may be configured to detect physical structures or components, identify damage states, incomplete assemblies, or spatial relationships. The analysis engine may be configured to generate structured representation of the analyzed environment.

In some embodiments, the AI task guidance system 106 includes a task inference engine 114 configured via hardware, software, firmware, and/or a combination thereof to perform one or more functions of the AI task guidance system 106. The task inference engine may be configured to determine or more task based on identified conditions or user-specified objectives (e.g., user-specified task objectives). The task inference engine may be configured to select predefined task workflows or generate new task sequences. The task inference engine may be configured to decompose tasks into ordered execution steps.

In some embodiments, the AI task guidance system 106 includes a feedback and progress tracking module 116 configured via hardware, software, firmware, and/or a combination thereof to perform one or more functions of the AI task guidance system 106. The feedback and progress tracking module enables closed-loop task completion. The feedback and progress tracking module may be configured to receive user confirmations of step completion. The feedback and progress tracking module may be configured to receive updated visual input depicted task progress. The feedback and progress tracking module may be configured to track task state and progression. The feedback and progress tracking module may be configured to trigger adaptive modification to subsequent instructions.

In some embodiments, the AI task guidance system 106 includes a data storage module configured via hardware, software, firmware, and/or a combination thereof to perform one or more functions of the AI task guidance system 106. The data storage module may be configured to store task state information, progress history, temporary visual input, and/or instructional context data. In some embodiments, the data storage module may store the data locally on the user device, remotely, or both depending on the implementation.

It will be understood that while many of the aspects and elements presented in FIG. 1 are shown as discrete, separate elements, other configurations may be used in connection with the methods, apparatuses, computer readable media, and computer programs described herein, including configurations that combine, omit, separate, or add aspects or elements. The various functions of the system environment 100 may be performed by other arrangements of one or more computing devices or computing systems without departing from the scope of the present disclosure. For example, in some embodiments, the functions of one or more of the illustrated elements in FIG. 1 may be performed by a single computing device or by multiple computing devices, which devices may be local or cloud based.

Additionally, while FIG. 1 illustrates certain components as separate, standalone entities communicating over the communications network, various embodiments are not limited to this configuration. In other embodiments, one or more components may be directly connected and/or share hardware such that connection(s) between the one or more components over the communications network are altered and/or rendered unnecessary. For example, in some embodiments, the user device 102 may include some or all of the AI task guidance system 106, such that an external communications network is not required.

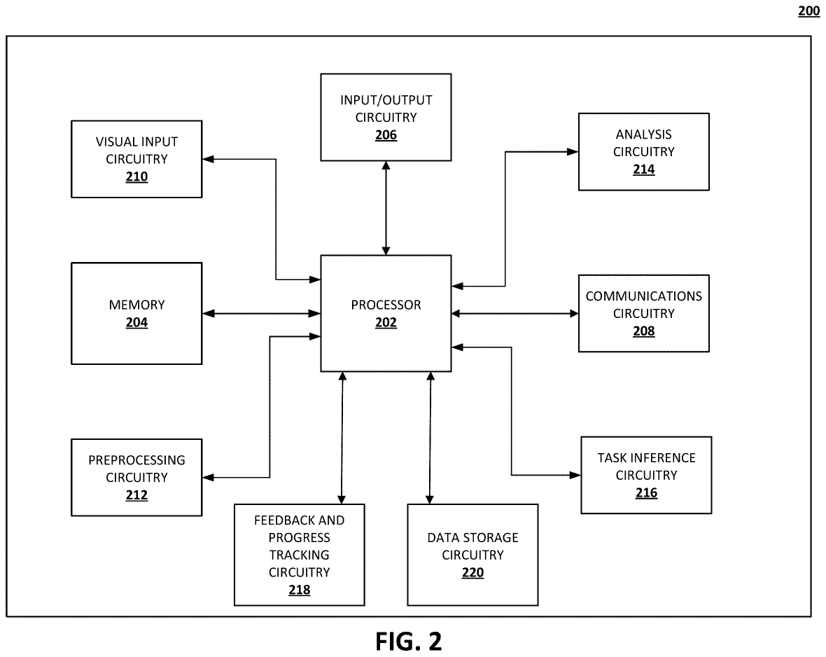

FIG. 2 illustrates a block diagram of an example apparatus that may be specially configured in accordance with at least one example embodiment of the present disclosure. Specifically, FIG. 2 depicts an example apparatus 200 (“apparatus 200”) specially configured in accordance with at least some example embodiments of the present disclosure. In some embodiments, the AI task guidance system 106 and/or a portion thereof is embodied by one or more system(s), such as the apparatus 200 as depicted and described in FIG. 2. The apparatus 200 includes processor 202, memory 204, input/output circuitry 206, communications circuitry 208, visual input circuitry 210, preprocessing circuitry 212, analysis circuitry 214, task inference circuitry 216, feedback and progress tracking circuitry 218, and data storage circuitry 220. In some embodiments, the apparatus 200 is configured, using one or more of the processor 202, memory 204, input/output circuitry 206, communications circuitry 208, visual input circuitry 210, and/or data storage circuitry 220, to execute and perform the operations described herein. The apparatus 200 may be configured to execute the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the apparatus 200 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present invention.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present invention while configured accordingly. Alternatively, as another example, when the processor 202 is embodied as an executor of software instructions, the instructions may specifically configure the processor 202 to perform the algorithms and/or operations described herein when the instructions are executed.

In some embodiments, the apparatus 200 may include input/output circuitry 206 that may, in turn, be in communication with processor 202 to provide output to the user and, in some embodiments, to receive an indication of a user input. The input/output circuitry 206 may comprise a user interface and may include a display, and may comprise a web user interface, a mobile application, a query-initiating computing device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communications circuitry 208 may include the circuitry for interacting with the antenna/antennae to cause transmission of signals via the antenna/antennae or to handle receipt of signals received via the antenna/antennae.

In some embodiments, the apparatus 200 includes visual input circuitry 210. The visual input circuitry 210 includes hardware, software, firmware, and/or a combination thereof, configured to, with the processor 202, memory 204, input/output circuitry 206 and/or communications circuitry 208, perform one or more functions associated with the visual input module 108 (as described above with reference to FIG. 1). In some embodiments, the visual input circuitry 210 may be configured to receive and/or transmit data, objects, and/or the like from and/or to one or more components of the apparatus 200, through, for example, the use of applications or APIs executed using a processor, such as the processor 202. It should also be appreciated that, in some embodiments, the visual input circuitry 210 may include a separate processor, specially configured field programmable gate array (FPGA), or application specific interface circuit (ASIC) to provide or otherwise facilitate access to such data, objects, and/or the like used by one or more other components of the apparatus 200. The visual input circuitry 210 may also provide for communication with other components of the apparatus, system and/or external systems via a network interface provided by the communications circuitry 208.

In some embodiments, the apparatus 200 includes preprocessing circuitry 212. The preprocessing circuitry 212 includes hardware, software, firmware, and/or a combination thereof, configured to, with the processor 202, memory 204, input/output circuitry 206 and/or communications circuitry 208, perform one or more functions associated with the preprocessing module 110 (as described above with reference to FIG. 1). In some embodiments, the preprocessing circuitry 212 may be configured to receive and/or transmit data, objects, and/or the like from and/or to one or more components of the apparatus 200, through, for example, the use of applications or APIs executed using a processor, such as the processor 202. It should also be appreciated that, in some embodiments, the preprocessing circuitry 212 may include a separate processor, specially configured field programmable gate array (FPGA), or application specific interface circuit (ASIC) to provide or otherwise facilitate access to such data, objects, and/or the like used by one or more other components of the apparatus 200. The preprocessing circuitry 212 may also provide for communication with other components of the apparatus, system and/or external systems via a network interface provided by the communications circuitry 208.

In some embodiments, the apparatus 200 includes analysis circuitry 214. The analysis circuitry 214 includes hardware, software, firmware, and/or a combination thereof, configured to, with the processor 202, memory 204, input/output circuitry 206 and/or communications circuitry 208, perform one or more functions associated with the analysis engine 112 (as described above with reference to FIG. 1). In some embodiments, the analysis circuitry 214 may be configured to receive and/or transmit data, objects, and/or the like from and/or to one or more components of the apparatus 200, through, for example, the use of applications or APIs executed using a processor, such as the processor 202. It should also be appreciated that, in some embodiments, the analysis circuitry 214 may include a separate processor, specially configured field programmable gate array (FPGA), or application specific interface circuit (ASIC) to provide or otherwise facilitate access to such data, objects, and/or the like used by one or more other components of the apparatus 200. The analysis circuitry 214 may also provide for communication with other components of the apparatus, system and/or external systems via a network interface provided by the communications circuitry 208.

In some embodiments, the apparatus 200 includes task inference circuitry 216. The task inference circuitry 216 includes hardware, software, firmware, and/or a combination thereof, configured to, with the processor 202, memory 204, input/output circuitry 206 and/or communications circuitry 208, perform one or more functions associated with the task inference engine 114 (as described above with reference to FIG. 1). In some embodiments, the task inference circuitry 216 may be configured to receive and/or transmit data, objects, and/or the like from and/or to one or more components of the apparatus 200, through, for example, the use of applications or APIs executed using a processor, such as the processor 202. It should also be appreciated that, in some embodiments, the task inference circuitry 216 may include a separate processor, specially configured field programmable gate array (FPGA), or application specific interface circuit (ASIC) to provide or otherwise facilitate access to such data, objects, and/or the like used by one or more other components of the apparatus 200. The task inference circuitry 216 may also provide for communication with other components of the apparatus, system and/or external systems via a network interface provided by the communications circuitry 208.

In some embodiments, the apparatus 200 includes feedback and progress tracking circuitry 218. The feedback and progress tracking circuitry 218 includes hardware, software, firmware, and/or a combination thereof, configured to, with the processor 202, memory 204, input/output circuitry 206 and/or communications circuitry 208, perform one or more functions associated with the feedback and progress tracking module 116 (as described above with reference to FIG. 1). In some embodiments, the feedback and progress tracking circuitry 218 may be configured to receive and/or transmit data, objects, and/or the like from and/or to one or more components of the apparatus 200, through, for example, the use of applications or APIs executed using a processor, such as the processor 202. It should also be appreciated that, in some embodiments, the feedback and progress tracking circuitry 218 may include a separate processor, specially configured field programmable gate array (FPGA), or application specific interface circuit (ASIC) to provide or otherwise facilitate access to such data, objects, and/or the like used by one or more other components of the apparatus 200. The feedback and progress tracking circuitry 218 may also provide for communication with other components of the apparatus, system and/or external systems via a network interface provided by the communications circuitry 208.

In some embodiments, the apparatus 200 includes an data storage circuitry 220. The data storage circuitry 220 may include hardware components, software components, and/or a combination thereof configured to, with the processor 202, memory 204, input/output circuitry 206 and/or communications circuitry 208, perform one or more functions associated with the data storage module 118 (as described above with reference to FIG. 1). In some embodiments, the data storage circuitry 220 may be configured to receive and/or transmit data, objects, and/or the like from and/or to one or more components of the apparatus 200, through, for example, the use of applications or APIs executed using a processor, such as the processor 202. It should also be appreciated that, in some embodiments, the data storage circuitry 220 may include a separate processor, specially configured field programmable gate array (FPGA), or application specific interface circuit (ASIC) to provide or otherwise facilitate access to such data, objects, and/or the like used by one or more other components of the apparatus 200. The data storage circuitry 220 may also provide for communication with other components of the apparatus, system and/or external systems via a network interface provided by the communications circuitry 208.

Additionally or alternatively, in some embodiments, two or more of the sets of circuitries embodying processor 202, memory 204, input/output circuitry 206, communications circuitry 208, visual input circuitry 210, preprocessing circuitry 212, analysis circuitry 214, task inference circuitry 216, feedback and progress tracking circuitry 218, and data storage circuitry 220 are combinable. Alternatively or additionally, in some embodiments, one or more of the sets of circuitry perform some or all of the functionality described associated with another component. For example, in some embodiments, two or more of the sets of circuitry embodied by processor 202, memory 204, input/output circuitry 206, and communications circuitry 208, visual input circuitry 210, preprocessing circuitry 212, analysis circuitry 214, task inference circuitry 216, feedback and progress tracking circuitry 218, and data storage circuitry 220 are combined into a single module embodied in hardware, software, firmware, and/or a combination thereof. Similarly, in some embodiments, one or more of the sets of circuitry, may be combined with the processor 202, such that the processor 202 performs one or more of the operations described above with respect to each of these sets of circuitry.

It is also noted that all or some of the information discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

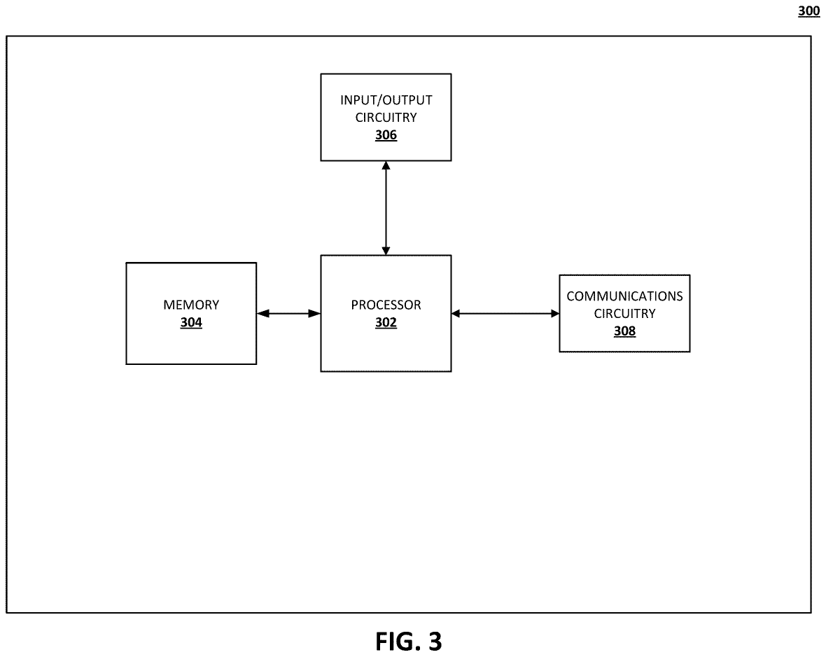

Referring now to FIG. 3, a user device may be embodied by one or more computing systems, such as apparatus 300 shown in FIG. 3. The apparatus 300 may include processor 302, memory 304, input/output circuitry 306, and a communications circuitry 308. Although these components 302-308 are described with respect to functional limitations, it should be understood that the particular implementations necessarily include the use of particular hardware. It should also be understood that certain of these components 302-308 may include similar or common hardware. For example, two sets of circuitries may both leverage use of the same processor, network interface, storage medium, or the like to perform their associated functions, such that duplicate hardware is not required for each set of circuitries.

In some embodiments, the processor 302 (and/or co-processor or any other processing circuitry assisting or otherwise associated with the processor) may be in communication with the memory 304 via a bus for passing information among components of the apparatus. The memory 304 is non-transitory and may include, for example, one or more volatile and/or non-volatile memories. In other words, for example, the memory 304 may be an electronic storage device (e.g., a computer-readable storage medium). The memory 304 may include one or more databases. Furthermore, the memory 304 may be configured to store information, data, content, applications, instructions, or the like for enabling the apparatus 300 to carry out various functions in accordance with example embodiments of the present invention.

The processor 302 may be embodied in a number of different ways and may, for example, include one or more processing devices configured to perform independently. In some preferred and non-limiting embodiments, the processor 302 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 302 may be configured to execute instructions stored in the memory 304 or otherwise accessible to the processor 302. In some preferred and non-limiting embodiments, the processor 302 may be configured to execute hard-coded functionalities. As such, whether configured by hardware or software methods, or by a combination thereof, the processor 302 may represent an entity (e.g., physically embodied in circuitry) capable of performing operations according to an embodiment of the present invention while configured accordingly. Alternatively, as another example, when the processor 302 is embodied as an executor of software instructions (e.g., computer program instructions), the instructions may specifically configure the processor 302 to perform the algorithms and/or operations described herein when the instructions are executed.

In some embodiments, the apparatus 300 may include input/output circuitry 306 that may, in turn, be in communication with processor 302 to provide output to the user and, in some embodiments, to receive an indication of a user input. The input/output circuitry 306 may comprise a user interface and may include a display, and may comprise a web user interface, a mobile application, a query-initiating computing device, a kiosk, or the like.

In embodiments in which the apparatus 300 is embodied by a limited interaction device, the input/output circuitry 306 includes a touch screen and does not include, or at least does not operatively engage (i.e., when configured in a tablet mode), other input accessories such as tactile keyboards, track pads, mice, etc. In other embodiments in which the apparatus is embodied by a non-limited interaction device, the input/output circuitry 306 may include at least one of a tactile keyboard (e.g., also referred to herein as keypad), a mouse, a joystick, a touch screen, touch areas, soft keys, and other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 304, and/or the like).

The communications circuitry 308 may be any means such as a device or circuitry embodied in either hardware or a combination of hardware and software that is configured to receive and/or transmit data from/to a network and/or any other device, circuitry, or module in communication with the apparatus 300. In this regard, the communications circuitry 308 may include, for example, a network interface for enabling communications with a wired or wireless communication network. For example, the communications circuitry 308 may include one or more network interface cards, antennae, buses, switches, routers, modems, and supporting hardware and/or software, or any other device suitable for enabling communications via a network. Additionally, or alternatively, the communications circuitry 308 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

### V. EXAMPLE SYSTEM OPERATIONS

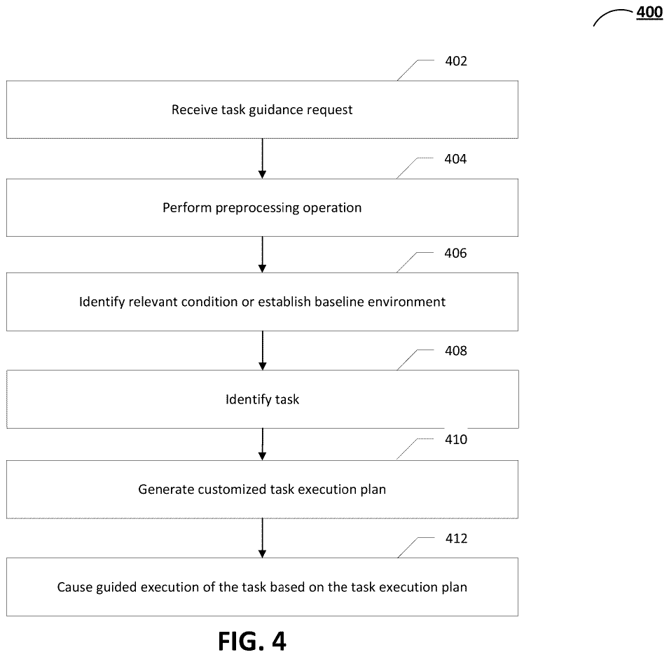

FIG. 4 illustrates an example flowchart diagram of an example intelligent task guidance process 400 in accordance with some embodiments of the present disclosure. The process 400 may be implemented by one or more computing devices, entities, and/or systems described herein. FIG. 4 illustrates an example process 400 for explanatory purposes. Although the example process 400 depicts a particular sequence of steps/operations, the sequence may be altered without departing from the scope of the present disclosure. For example, some of the steps/operations depicted may be performed in parallel or in a different sequence that does not materially impact the function of the process 400. In other examples, different components of an example device or system that implements the process 400 may perform functions at substantially the same time or in a specific sequence.

The process 400 includes, at step/operation 402, receiving a task guidance request via a user device associated with a user. For example, the AI task guidance system 106 may receive, from a user device associated with a user, a task guidance request that identifies a task, wherein the task guidance request comprises one or more of natural language text, an image, or a video. In some embodiments, the task is a physical task such as an action, operation, or activity that involves manipulation of or interaction with a tangible object, environment, or other entities. In some embodiments, the task comprises one of a home repair, appliance repair, automotive maintenance, craft assembly, accessibility assistance, or vocational training.

The user device may be a mobile device such as smartphone, a laptop, a desktop, or other forms of user device. The task guidance request comprises any communication, message, signal, or input representative and/or indicative of a request for intelligent task guidance, as described herein. The task guidance request may be a visual input-based task guidance request or a natural language-based task guidance request.

The visual input-based task guidance request conveys information through a visual input representative of a target entity. For example, the visual input-based task guidance request may comprise a visual input representative of a target entity. The target entity may be any object, item, element, device, environment, product or other identifiable unit that is subject of a task guidance request. The target entity may be identifiable unit with respect to which a task is performed. The target entity may be acted upon, modified, analyzed, created, or otherwise involved in the execution of a task. In some examples, the target entity may be a physical entity such as a device, equipment, or product. In some examples, the target entity may be a digital entity such as a software component, a file, or a data object. In some examples, the target may be a conceptual entity such as a project, a goal, or a task state.

Non-limiting examples of a visual input includes images such as still images, live videos (e.g., video sequence captured in real time), pre-recorded videos, or other visual media capable of depicting a target entity. In this regard, the visual input may comprise a visual representation of a target entity, wherein the visual representation may be in the form of images(s), video(s), or other visual media. The one or more images may comprise still images(s). The visual input may be captured via any of a variety of techniques. In some embodiments, the AI task guidance system 106 may leverage a camera associated with the user device to capture the visual input.

In this regard, in some embodiments, the step/operation 402, comprises receiving a visual input representative of a target entity via a user device, wherein the target entity may comprise a physical object, an environment, a task state, or other identifiable unit. In some examples, the visual input may depict or otherwise identify a task to be complete. By way of example, the visual input may depict a damaged structure, a partially completed assembly, a construction site, appliance mechanical component, or other physical condition requiring procedural intervention. In some examples, the visual input may depict a scene, wherein the scene may be the target entity or comprise the target entity.

The natural language-based task guidance request conveys information through a textual input or voice input that identifies a target entity. In some examples, the textual input may be received via a text field input field of a user interface rendered on a display of user device. In some examples, the voice input may be received via voice user interfaces or any voice capture devices capable of detecting, receiving, recording, or capturing audio signals. Such voice capture devices may include a user device or voice capture mechanism included in a user device configured to detect and convert audio signals from a user's voice into digital data or text. In some examples, the natural language-based task guidance request may identify the target entity therein. For example, one or more word tokens within the natural language-based task guidance request may represent the target entity. A non-limiting example of a natural language-based task guidance request is “I need help fixing my leaky sink,” wherein “sink” represents the target entity.

In some embodiments, the AI task guidance system 106 may obtain a visual input representative of the target entity subsequent to the natural language-based task guidance request. For example, the AI task guidance system 106 may transmit a request (e.g., context request) to the user via a user interface rendered on the user device that directs the user to capture visual input representative of the target entity identified within the natural language-based task guidance request. In this regard, in some embodiments, the AI task guidance system 106 may cause a visual representation of a target entity to be captured via a user device.

In this regard, in some embodiments, step/operation 402 comprises receiving, from a user device associated with a user, a task guidance request that identifies a task, wherein the task guidance request comprises one or more of natural language text, an image, or a video. For example, the task guidance request may be representative of a multimodal input.

In some embodiments, the process 400 includes, at step/operation 404, performing one or more preprocessing operations on the visual input. For example, the AI task guidance system 106 may perform preprocessing operations configured to prepare the captured visual input for subsequent analysis, enabling efficient and accurate downstream analysis. The preprocessing operating may include cleaning, normalizing, formatting, filtering, or otherwise enhancing the quality of the visual input for subsequent analysis. In some embodiments, the preprocessing operations include image normalization or enhancement, frame extraction from video input, noise reduction, and/or feature extraction. The image normalization operation may be configured to adjust, standardize, or transform the characteristics of a captured image to a desired or specified format. In some examples, image normalization may include resizing, cropping, or alignment. The frame extraction operation may be configured to identify and extract one or more frames or still images from a captured video. The noise reduction operation may be configured to reduce, attenuate, or remove unwanted noise or interference from the visual input, which may include audio signal, captured image, captured video, or other forms of visual input, as described above. The feature extraction operation may be configured to identify and extract meaningful characteristics, attributes, and/or patterns from the visual input.

In some embodiments, the step/operation 406 comprises analyzing the task guidance request (e.g., one or more inputs thereof) to identify a task context comprising a task category, an execution environment, and a user skill level. For example, the AI task guidance system 106 may analyze the visual input (or processed visual input) and/or text input representative of the task guidance request (or otherwise derived based on the task guidance request) to identify a task context, wherein the task context specifies a task category, an execution environment, and/or a user skill level. In some embodiments, analyzing the task guidance request comprises fusing multimodal input data associated with the task guidance request into a unified task-state representation that informs subsequent instructional generation. For example, analyzing the task guidance request may comprise fusing natural language text, image video, and/or video representative of the task guidance request or otherwise derived from the task guidance request into a unified task-state. The unified task-state may comprise or otherwise may be indicative of a consolidated, integrated, or comprehensive representation of the current status, progress, condition, or attributes associated with the task at a given point in time. The unified task-state may comprise datum representative and/or indicative of the current stage of the task, completed subtasks or steps associated with task, pending subtasks or steps associated with the task, resource allocations, intermediate results, and/or the like. The task category may comprise a classification, type, or grouping used to distinguish, characterize, the tasks based on, for example, shared characteristics, attributes, purpose, requirements, and/or the like. In this regard, the task context may specify a task category of one or more task categories. In some embodiments, the task context may specify a task category representative and/or indicative of a repair or diagnostic task. In some embodiments, the task context may specify a task category representative and/or indicative of a task that has not yet started such as a building task, installation task, or assembly task.

In some embodiments, analyzing the task guidance request comprises analyzing the visual input or preprocessed visual input to generate a visual analysis output. In some embodiments, the visual analysis output comprises entity condition data for one or more entities depicted within the visual input. Alternatively or additionally, in some embodiments, the visual analysis output comprises baseline environment data associated with user specified task objective. In some embodiments, the baseline environment data comprises measurements, observations, or other data that characterizes the state, attributes, or conditions of an environment at a point in time. For example, the baseline environment data may comprise measurements for one or more parameters such as spatial configuration, lighting, or environmental parameters (e.g., temperature, humidity, pressure, and/or the like) configured to establish a baseline environment in relation to user specified task objective.

In this regard, the step/operation 406 may include identifying one or more entity conditions relevant for task execution and/or to establish a baseline environment in relation to user-specified task objective. In some embodiments, the user-specified task objective may be provided via a natural language-based task guidance request, as described above with respect to step/operation 402. In some embodiments, the AI task guidance system 106 may leverage processing techniques such as keyword extraction, parsing, and/or natural language processing, to identify the user-specified task objective. The AI task guidance system may apply such techniques to the natural language-based task guidance request to determine the user-specified task objective. In this regard, the AI task guidance system 106 may perform visual analysis operation configured to generate entity condition data for one or more entities depicted within the visual input.

In some embodiments, the visual analysis operation comprises detecting entities (e.g., objects, material, or components) depicted in the visual input. In some embodiments, the visual analysis operation may include determining entity characteristics data associated with the detected entities. The entity characteristics data may comprise attributes, characteristics, and/or other information associated with an entity. For example, the entity characteristics data may comprise information about the entity including, but not limited to, entity identifier, entity type, and/or other relevant information about the entity. For example, where the entity is a device, the entity characteristics data may comprise identifying data such as device identifier that uniquely identifies the device, device manufacturer, device model, and/or the like; physical characteristics of the device such as size, color, and/or the like; device specifications such as configuration settings and/or operational parameters; device components list; and/or the like. In some embodiments, one or more of the detected entities may be the target entity. In this regard, in some embodiments, the visual analysis may include determining entity characteristics data associated with the target entity. In some embodiments, the AI task guidance system 106 may leverage the entity characteristics data to determine the entity condition data. For example, the AI task guidance system 106 may determine the entity condition data based at least in part on the entity characteristics data. For example, the entity characteristics data may provide or serve as reference data.

In some embodiments, the AI task guidance system 106 may identify the target entity from one or more entities depicted within the visual input and perform visual analysis operation focused on generating entity condition data for the target entity. For example, in some embodiments, the AI task guidance system 106 may perform a visual analysis operation only with respect to the target entity, wherein the entity condition data may be generated only for the target entity.

In some embodiments, the visual analysis operation comprises determining physical condition associated with the detected entities. In some embodiments, determining the physical condition associated with a detected entity comprises determining abnormal condition(s) associated with the detected entity. An abnormal condition may refer to any state, characteristic, attribute, circumstance, or occurrence associated with the entity that deviates from normal predefined standard of operation, behavior, appearance, or performance. An abnormal condition may include a malfunction, an error, a fault, failure, irregularity, or the like. In some embodiments, the abnormal condition may include damage, misalignments, missing elements, or incomplete assemblies. In some embodiments, determining an abnormal condition associated with a detected entity includes determining a degree of the abnormal condition. In this regard, in some embodiments, determining the physical condition associated with a detected entity may comprise identifying abnormal condition(s) associated with the detected entity along with the degree of the abnormal condition(s).

In some embodiments, the visual analysis operation may include determining a current task stage within a larger workflow. Such task stage may refer to a phase, step, or segment within execution, progression, or lifecycle of a task. The task stage may be representative and/or indicative of a defined point in the lifecycle of a task, such as starting/initiation, preparation, execution, verification, or completion. In some embodiments, the visual analysis operation may include determining a starting state relative to an intended outcome such as intended project outcome.

In this some embodiments, the entity condition data output of the step/operation 406 may take the form of structured data (e.g., structured entity condition data) representative of the identified physical condition for a target entity or each of one or more entities depicted within the visual input.

In some embodiments, the visual analysis operation comprises analyzing the visual input based on to user specified task objective to generate baseline environment data establishes a baseline environment in relation to user specified task objective, as described above. In this some embodiments, the baseline environment condition data output of the step/operation 406 may take the form of structured data (e.g., structured baseline condition data) representative of a baseline of an environment identified via user-specified task objective.

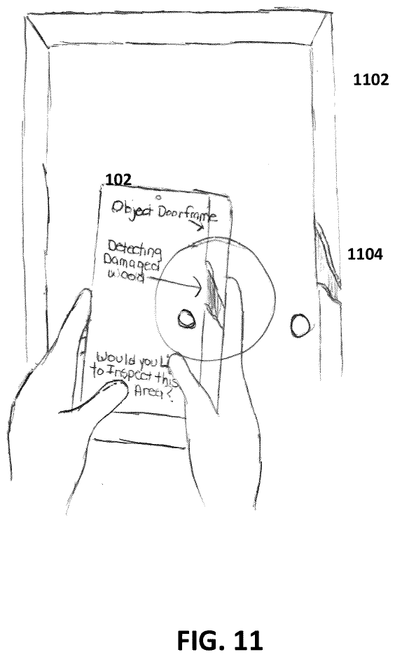

The AI task guidance system 106 may employ one or more techniques to perform or facilitate the visual analysis operation. Non-limiting examples of such analysis techniques include image recognition techniques, video analysis techniques, computer vision techniques, and/or motion detection techniques. In some embodiments, the AI task guidance system 106 may leverage a machine learning (ML) model or AI model to perform the analysis operation. The machine learning model or AI model may be configured and/or trained to receive the visual input and perform a visual analysis operation based on the visual input to generate a visual analysis output comprising entity condition data for one or more entities depicted within the visual input or baseline environment data, as described above. The machine learning model or AI model may employ one or more of the aforementioned analysis techniques. In some embodiments, the machine learning model or AI model may include one or more algorithms configured to perform such analysis techniques. In some embodiments, the AI model may be a generative AI model. By way of non-limiting example, as shown in FIG. 11, the AI task guidance system 106 may determine an abnormal condition 1104 associated with a target entity (e.g., door 1102 in the depicted example) by applying image analysis algorithm(s) or other ML/AI algorithms to the captured image or video of the target entity.

In some embodiments, the AI task guidance system 106 includes an augmented reality guidance module configured via hardware, software, firmware, and/or a combination thereof to perform and/or facilitate visual overlay operations that enable the AI task guidance system 106 to provide visual overlay instructions, visual overlay inspections, and/or other functionalities. For example, the augmented reality guidance module may be configured to overlay visual cues (e.g., visual inspection cues or visual overlay cues) onto a live camera view of the user device to perform such visual overlay operations, including visual inspection and visual instructions. In this regard, in some embodiments, the augmented reality guidance module may be configured to overlay visual inspection cues onto a live camera view of the user device for visual inspection, as shown in FIG. 11. In some embodiments, one or more components of the AI task guidance system 106 may include the augmented reality guidance module.

In some embodiments, the process 400 includes, at step/operation 408, identifying a task based on input data comprising one or more of the task guidance request, visual input, entity characteristics data, entity condition data, baseline environment data, or user-specified task objective. In some embodiments, the input data comprises at least one of the entity condition or baseline environment data. A task may comprise an operation, unit of work, actions, or similar terms to be performed.

In some embodiments, the AI task guidance system 106 may leverage a machine learning model or AI model configured and/or trained to receive input data, and perform a task determination and decomposition operation configured to identify a task associated with the target entity. For example, the AI task guidance system 106, using a machine learning model or AI model, may identify a task based at least in part on the entity condition data or baseline environment data. In this regard, in some embodiments, identifying the task may comprise selecting a task corresponding to an entity condition identified with the entity condition data. For example, the AI task guidance system 106 may select a predefined task for an entity condition identified within the entity condition data when the condition is a recognized condition. A recognized condition may correspond to known abnormal condition that has been assigned to a task label or classification. For example, a recognized condition may refer to a condition that has been previously classified into a predefined task or otherwise previously associated with a predefined task by the AI task guidance system 106.

In some embodiments, identifying the task may comprise generating the task. For example, where an entity condition identified within the entity condition data is not a recognized condition, the AI task guidance system 106 may generate a task that is not previously defined. In this regard, in some embodiments, identifying the task may comprise generating additional task class or label, and associating the additional task class/label with the entity condition.

In some embodiments, identifying the task may comprise decomposing a task, such as a complex task, into an ordered sequence of execution steps corresponding to the detected entity condition or intended outcome. For example, the AI task guidance system 106 may decompose a selected task or generated task into an ordered sequence of execution steps. In some embodiments, each execution step (also referred to herein as procedural step) may be associated with one or more units of work (e.g., actions to be completed), relevant tools or materials, and/or preconditions or dependencies. For example, in some embodiments, the task decomposition operation may include analyzing the selected task or generated task to identify execution steps corresponding to logical divisions, sequence of the execution steps and associated actions/units of work, and dependencies associated with the execution steps and associated actions/units of work. In some embodiments, identifying the task may comprise identifying the target entity(s) associated with the task.

In some embodiments, the AI task guidance system 106 leverages a dynamic task decomposition algorithm to decompose the task into the ordered sequence of execution steps. In some embodiments, the AI task guidance system 106 may decompose the task into an ordered sequence of execution steps using a dynamic task decomposition algorithm that adapts step granularity based at least in part on user skill level. The dynamic task decomposition algorithm or computation process configured to break down a task into actions (e.g., units of works) in a way that adapts, changes, or adjusts based on conditions during task execution, user feedback, or other factors. The dynamic task decomposition algorithm may evaluate attributes or characteristics of the task, visual input, user skill level, environmental conditions (such as condition of execution environment specified in the task context), objectives such as user-specified task objectives, and/or constraints to decompose the task in to execution steps.

The dynamic task decomposition algorithm may be configured to generate an output comprising dynamic execution steps in that the execution steps, execution step count (e.g., number of execution steps), the sequence of the execution steps, the granularity of the execution steps, and/or the dependencies may vary depending on inputs, including user interaction data received during task execution as further described below; context, including changing conditions during task execution; intermediate results; and/or other factors. For example, the dynamic task decomposition algorithm may be configured to refine the task decomposition as the task progresses such as during task execution to adapt to changing circumstances, additional information, or requirement changes, execution environment changes, and/or other factors. In some embodiments, the dynamic task decomposition algorithm is configured to adjust, based on prior task performance data associated with the user, the execution steps count (e.g., number of execution steps), execution steps complexity (e.g., complexity of the execution steps), and/or execution steps sequence (e.g., sequence of the execution steps).

The dynamic task decomposition algorithm may utilize rules, heuristics, optimization, or machine learning methodologies/techniques to break down a task. For example, in some embodiments, the dynamic decomposition algorithm may comprise a machine learning algorithm or AI algorithm.

The process 400 includes, at step/operation 410, generating a customized task execution plan based on the identified task. For example, the AI task guidance system 106 may generated a customized task execution plan based on the execution steps associated with the identified task from step/operation 408. The customized task execution plan defines a strategy for completing the identified task. The customized task execution plan comprises instructional data including one or more actions. For example, the AI task guidance system 106 may generate a customized task execution plan that comprises instructional data (e.g., task instructions).

The task execution plan may comprise task instructions corresponding to the execution steps. The task instructions may define or otherwise representative of a step-by-step work flow of actions (units of work) that are to performed to accomplish the task. As described above, each procedural step may be associated with one or more such actions. In some embodiments, the customized task execution plan includes tool recommendation (e.g., one or more recommended tools or materials) for performing various action(s) defined in the workflow. For example, in some embodiments, the instructional data further comprises dynamically generated tool and material recommendations based on one or more of the task context or execution environment. In some embodiments, the instructional data further comprises safety-critical steps that are emphasized, reordered, or locked against skipping based on risk assessment associated with the task

In some embodiments, the task instructions may be presented or otherwise rendered on the user device in any of a variety of forms including, but not limited to, textual instructions, annotated images, animations, synthesized instructional video or visual sequences. In some embodiments, the presentation and/or rendering of the task instructions may be configured for being displayed sequentially (e.g., one step at a time) while emphasizing actions identified as critical. In some embodiments, the presentation and/or rendering of the task instructions comprises adjusting complexity based on user preferences or detected user behavior.

In this regard, in some embodiments, the task execution plan is a dynamic task execution plan that adapts to changing circumstances during task execution, wherein generating the customized task execution plan may comprises dynamically generating or refining one or more portions/segments of the customized task execution plan during execution of the task. The dynamic task execution plan may refer to a task execution plan that is capable of being modified, updated, reconfigured, updated, or otherwise refined during creation or execution of the of the task execution plan. A dynamic task execution plan may be modified, updated, reconfigured, updated, or otherwise refined in real-time based on additional information, changing conditions, feedback, progress status, intermediate results, or other factors. For example, a dynamic task execution plan may be refined.

The dynamic task generation enables tailoring the task execution plan to the user, particular context, and changing conditions. The AI task guidance system 106 may implement techniques for monitoring progress of task execution, receiving and analyzing user feedback, analyzing and/or evaluating results/outcomes at different stages of the customized task execution plan, identifying opportunities of improvements, and/or dynamically refining the customized task execution plan. In some embodiments, such techniques may include AI algorithm(s) configured to perform such aforementioned functions. In some embodiments, the AI task guidance system 106 may leverage one or more AI models that include such AI algorithm(s). In some embodiments, the AI model may be a generative AI model such as a large language model.

In some embodiments, the customized task execution plan includes video content that conveys or otherwise presents the task execution plan (or portion thereof). In this regard, in some embodiments, generating the customized task execution plan may comprise generating video content that conveys or otherwise presents the task execution plan (or task instructions thereof) sequentially. In this regard, the video content may visually illustrate execution steps and associated actions defined within the customized task execution plan in distinct frames such that the task instructions may be presented via the user device one step at a time (e.g., step-by-step instructions). In some embodiments, the video content may demonstrate the actions (units of work). The video content may include audio that conveys the task instructions.

In some embodiments, the video content may comprise static video content and/or dynamic video content (e.g., real-time streaming). In this regard, in some embodiments, generating the customized task execution plan may comprise generating static video and/or dynamically generating video content. In some embodiments, the dynamically generated video content may be generated during an AI-guided interactive task execution session, as further described below. In some embodiments, the customized task execution plan may include links to video contents that may be dynamically generated during the AI-guided interactive execution session.

In some embodiments, dynamic video content refers to video content that is generated, modified, or adapted in real-time based on current condition, user feedback, context, or other factors during task execution. The dynamic video content may be tailored to the particular context or user, including user capabilities, environmental conditions, available tools, available data, and/or the like. The dynamic video content may be streamed or otherwise rendered on a display of the user device in real time. In some embodiments, the dynamic video content may include interactive elements that allows the user to navigate through the video content or influence the video content generated during task execution. In some embodiments, the AI task guidance system 106 leverages AI techniques, video synthesis techniques, and/or other dynamic video content creation techniques to generate the dynamic video content.

In this regard, in some embodiments, generating a customized task execution plan comprises synthesizing a personalized instructional video sequence (e.g., personalized instructional video) based on ordered sequence of execution steps, wherein the personalized instructional video sequence depicts the ordered sequence of execution steps, and wherein synthesizing the personalized instructional video sequence comprises dynamically generating the personalized instructional video sequence. For example, the AI task guidance system 106 may perform a synthesis operation configured to generate visual content, computer-generated imagery, or other visual representations based on the ordered sequence of execution steps. The synthesis operation may include generation of audio, narration, and/or the like. In some examples, the synthesis operation may include rendering, encoding formatting, or preparing the video sequence for storage, transmission, or playback. In some embodiments, synthesizing the personalized instructional video sequence comprises generating synthetic visual representations of task execution. The synthetic visual representation may comprise visual content, image, graphic, and/or other visual representations that is artificially generated, computationally created, or otherwise generated through automated processes rather than captured directly from physical world through photography, videography, or the like. In this regard, the synthetic visual representation may comprise computer-generated imagery, digitally created illustrations, procedurally generated visual, AI-generated images, simulate scenes, virtual environments, and/or the like.

In some embodiments, the AI task guidance system 106 may leverage an artificial intelligence (AI) video synthesis engine to generate synthetic visual representations of task execution or otherwise to generate a personalized instructional video sequence comprising synthetic visual representations of task execution (e.g., synthetic visual representation corresponding to the ordered sequence of execution steps or portion thereof). For example, synthesizing the personalized instructional video sequence may comprise generating synthetic visual representations of task execution using an AI video synthesis engine.

In some embodiments, synthesizing the personalized instructional video sequence comprises generating synthetic visual representations of task execution using an artificial intelligence (AI) video synthesis engine. For example, in some embodiments, the AI task guidance system 106 may leverage an AI video synthesis engine to generate the personalized instructional video sequence (e.g., personalized instructional video comprising a sequence of execution steps), wherein synthesizing the personalized instructional video sequence comprises generating synthetic visual representations of tack execution.

The AI video synthesis engine may comprise a system, module component, or computational framework that is configured to utilize AI techniques to generate synthesized video content comprising synthetic visual representations of task execution based on input comprising ordered sequence of execution steps. The AI video synthesis engine may be configured to receive the ordered sequence of execution steps as input and perform a synthesis operation to generate a synthetic visual representation of task execution corresponding to a personalized instructional video sequence. For example, the AI video synthesis engine may be configured to generate a personalized instructional video sequence comprising synthetic visual representation of task execution. The AI video synthesis engine may implement one or more of motion modeling, object interaction simulation, or procedural visualization to depict task execution. For example, the AI video synthesis engine may leverage motion modeling techniques, object interaction simulation techniques, or procedural visualization techniques to depict the task execution (e.g., to depict the ordered sequence of execution steps. In some embodiments, the AI video synthesis engine may be embodied by the AI task guidance system 106. For example, in some embodiments, the AI task guidance system 106 or one or more components of the AI task guidance system 106, as described above, may include the AI video synthesis engine.

In some embodiments, the customized execution plan or otherwise personalized instructional video sequence comprises segmented steps that are individually pausable, replayable, or recordable based on user interaction during task execution. In some embodiments, the customized task execution plan includes images, such as still images, that conveys or otherwise presents one or more task instructions. In this regard, in some embodiments, generating the customized task execution plan may comprise generating one or more images that conveys or otherwise presents one or more task instructions. The images may depict a scene, the target entity, other entities, and/or recommended tools. In some embodiments, the images may demonstrate one or more actions (units of work) to be completed. In some embodiments, the personalized instructional video sequence is generated uniquely for each user request (e.g., each task guidance request) and not reusable as a generic tutorial for multiple users. In some embodiments, the personalized instructional video sequence is optimized for task completion validation.

In some embodiments, at least a portion of the images may be dynamically generated. For example, in such some embodiments, at least a portion of the images may comprise dynamic images that are generated and/or rendered in real-time based on current condition, user feedback, context, or other factors during task execution. In this regard, in some embodiments, generating the customized task execution plan may comprise generating dynamic images. In some embodiments, the dynamically generated images may be generated during an AI-guided interactive task execution session, as further described below.

In some embodiments, the process 400 includes, at step/operation 412, causing performance of the task based on the customized task execution plan. For example, the AI task guidance system 106 may cause execution of the task (e.g., cause task execution process) based on the customized task execution plan configured to accomplish the task. In this regard, task execution may comprise executing the customized task execution plan, wherein executing the task execution plan comprises performing the work flow defined within the task execution plan. Task execution (also referred to herein as task execution process) may refer to the process of implementing or otherwise performing the execution steps and associated actions specified in the customized task execution plan and in accordance with a the defined sequence.

In some embodiments, causing performance of the task comprises initiates an AI-guided interactive task execution session configured to guide performance of the work flow by a user. The customized task execution plan may include confirmation steps (e.g., verification steps) configured to confirm successful completion of the execution steps and associated actions specified in the task execution plan and/or to determine task status or progress. For example, in some embodiments, the AI task guidance system 106 implements an adaptive guidance and error handling mechanism that is driven at least in part by user interaction data received during task execution.

In some example, the AI task guidance system 106 may prompt the user to provide such user interaction data. In some embodiments, the user may provide the interaction data (or portion thereof) without a prompt from the AI task guidance system 106. The user interaction data may be representative and/or indicative of task progress and/or additional context. Non-limiting examples of such user interaction data include confirmation of step completion by the user, updated visual input showing progress, corrections or user-initiated adjustments.

In this regard, in some embodiments, the AI task guidance system 106 may receive user interaction data that comprises or is representative of progress data from the user device during task execution process, and modify subsequent instructional output (e.g., subsequent instruction) presented to the user in real time based on one or more of detected deviations, detected errors, or incomplete execution of one or more execution steps (e.g., one or more previous execution steps completed during the task execution process).

For example, the AI task guidance system 106 may receive progress data from the user device and modify subsequent instructional output in real time based on detected deviations, detected errors, and/or incomplete execution of one or more execution steps during the task execution process, as further described herein. In this regard, in some embodiments, the AI task guidance system 106 receives progress data from the user device during task execution, and modifies subsequent instructional output in real time based on one or more of detected deviations, detected errors, or incomplete execution of one or more execution steps. In some embodiments, modifying the subsequent instructional output comprises analyzing the user interaction data to identify errors relative to or otherwise with respect to the ordered sequence of execution steps (or portion thereof). For example, in some embodiments, the user interaction data (or progress data thereof) may comprise user-recorded video of task execution. The AI task guidance system 106, in response to receiving the user-recorded video, may analyze the user recorded video to identify errors relative to the ordered sequence of execution steps. In some embodiments, the user-recorded video of task execution may comprise a video depicting execution of one or more previous steps or one or more corresponding actions taking by the user during task execution.

In some embodiments, the AI task guidance system 106 includes a skill progression engine configured to track user task history, and adjust future instructional generation based on accumulated skill data. For example, in some embodiments, the AI task guidance system 106 includes a skill progress engine configured via hardware, software, firmware, and/or a combination thereof to track user task history, and adjust future instructional generation based on accumulated skill data. In some embodiments, the skill progression engine is configured to identify transferable skills across one or more task categories, and modify instructional complexity based on the transferable skills. In some embodiments, one or more components of the AI task guidance system 106 includes the skill progression engine.

In this regard, the user interaction data may enable the AI task guidance system 106 determine whether a step or action has been successfully completed and/or inform subsequent instructions. For example, the AI task guidance system 106 may modify subsequent instructions based on the received user interaction data, as described above. In some embodiments, modifying subsequent instructions include, but not limited to, repeating or clarifying a step, adjusting step order (e.g., adjusting predefined sequence of steps), providing corrective guidance in response to detected errors identified based on the user interaction data, and/or escalating instruction detail when repeated failure is detected. The adaptive behavior of the AI task guidance system 106 enables the system to function as a closed-loop task completion assistant.

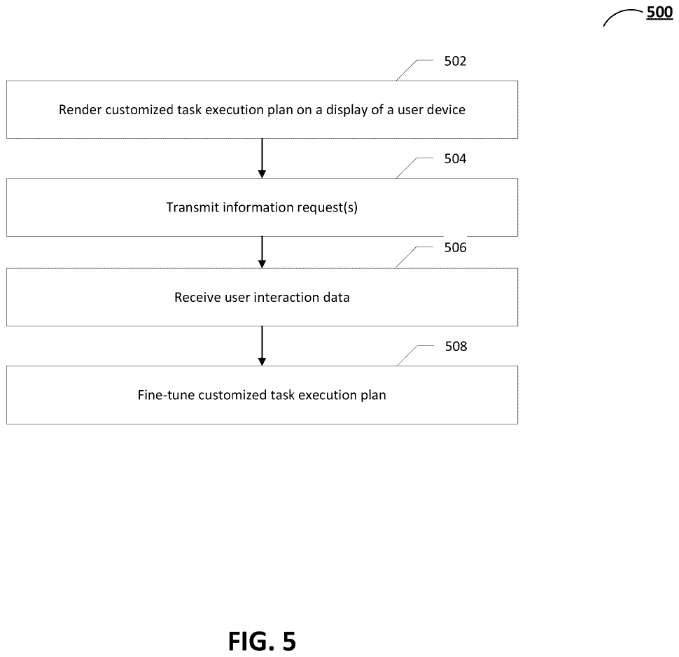

In some embodiments, the AI task guidance system 106 provides or otherwise implements an iterative task execution process that may include repeating one or more of the steps/operations of the process 400 until the task in determined to be complete, the user terminates the AI interactive session, or a predefined completion condition is satisfied/met. In some embodiments, a completion status may be recorded for later retrieval or continuation. In some embodiments, the step/operation 412 may be performed in accordance with the example process described in FIG. 5

As described above, the AI task guidance system 106 may be configured to provide adaptive task guidance that dynamically adjusts in response to user interaction, detected progress, and changing task conditions. In this regard, unlike static instructional systems, the AI task guidance system 106 continuously evaluates task execution and adaptively modifies guidance during task performance. In some embodiments, the AI task guidance system 106 may implement such personalized the task guidance based on one or more user-specific factors including, but not limited to, user-selected experience or skill level, observed interaction patterns, such as repeated confirmation or delays, user preferences related to instruction format, pacing, or detail level, and/or accessibility consideration including cognitive attention-related needs. In this regard, such personalization may influence the presentation of the customized task execution plan. For example, the number of step presented at a time, the level of explanation associated with each step, and/or the user of visual emphasis, repetition, or simplified language may be based at least in part on the user-specific personalization.

As further described below, the AI task guidance system 106 may be configured to receive feedback representative and/or indicative of task progress or execution quality, wherein such feedback may include user confirmation of step completion, updated visual input depicting completed or partially completed work, or user initiated corrections or requests for clarification. Based on the received feedback, the AI task guidance system 106 may validate successful completion of steps, detect errors, omissions, or deviations from expected outcomes, and/or modify subsequent instructions accordingly.

The AI task guidance system 106 may be configured to manage task complexity dynamically. For example, the AI task guidance system 106 may manage task complexity dynamically by gradually introducing additional details as needed. Escalating instructions specificity when repeated difficulty is detected, and/or simplify task presentation for novice users while maintaining efficiency for advanced users. This enables the system to support a wide range of user without requiring separate instruction content.

The AI task guidance system 106 may store task state and progress data to allow users to pause and resume tasks across multiple sessions. Upon resumption, the AI task guidance system 106 may restore the last completed step, re-evaluate the task state using updated visual input, and/or adjust guidance based on the changes since the previous session. This supports multi-day or multi-phase projects.

As further described below, the AI task guidance system 106 may be configured to detect potential errors of suboptimal execution based on visual analysis or user interaction patterns, and present corrective guidance. Such corrective guidance may include re-presenting a step with additional explanation, providing alternative methods to complete a step, introducing safety-related warnings or reminders, and/or adjusting task sequencing to address dependencies. In this regard, the AI task guidance system 106 reduces reliance on external assistance and improves task success rates.

FIG. 5 illustrates a flowchart diagram of an example AI-guided interactive task execution process 500 in accordance with at least some embodiments of the present disclosure. The process 500 may be implemented by one or more computing devices, entities, and/or systems described herein. FIG. 5 illustrates an example process 500 for explanatory purposes. Although the example process 500 depicts a particular sequence of steps/operations, the sequence may be altered without departing from the scope of the present disclosure. For example, some of the steps/operations depicted may be performed in parallel or in a different sequence that does not materially impact the function of the process 500. In other examples, different components of an example device or system that implements the process 500 may perform functions at substantially the same time or in a specific sequence.

In some embodiments, the process 500 includes, at step/operation 502 rendering a customized task execution plan on a display of a user device. In some embodiments, rendering the customized task execution plan on a display of a user device may be indicative of the beginning of an AI-guided interactive task execution session. In some embodiments, an AI-guided interactive task execution session refers to a period of communication or otherwise interaction between a user and the AI task guidance system 106 during which the AI task guidance system 106 provides step-by-step guidance to the user through a customized task execution plan to facilitate effective, efficient, and successful completion of a task. The AI-guided interactive task execution session may represent a portion of a AI interactive session between the user and the AI task guidance system 106 that begins when the AI task guidance system 106 renders a customized task execution plan (or portion thereof) on a display of the user device or otherwise prompts the user via a user interface to begin execution of a customized task execution plan rendered on a display of the user device. The AI interactive session that encompasses the AI-guided interactive task execution session may begin when the AI task guidance system 106 receives a task guidance request as described above with reference to FIG. 4.

In some embodiments, the AI-guided interactive task execution session may terminate/conclude when the task is determined to be completed, when the user terminates the session, or when a predefined completion condition is satisfied. The AI-guided interactive task execution session may involve multiple interactive exchanges between the user and the AI task guidance system 106, where the AI task guidance system 106 serves an AI assistant configured to provide step-by-step adaptable instructions that guides efficient and effective execution of the task.

The user may provide interactive data in the form of textual inputs, voice inputs, images, visual inputs, gestures, or other forms of communication to the AI task guidance system 106 during the AI-guided interactive task execution session. The AI task guidance system 106 may communicate adaptable step-by-step instructions, requests (e.g., additional context/information requests, confirmation requests, status requests, and/or the like) and/or responses to user queries during the AI-guided interactive task execution session.

The AI-guided interactive task execution session may maintain context, history, or state information that allows the AI task guidance system 106 to provide informed, relevant, and personalized responses and across multiple interactions within the AI-guided interactive task execution session.

In some embodiment, the process 500 includes, at step/operation 504 transmitting one or more information requests to obtain, in real time, user interaction data associated with execution of the task. In some embodiments, the one more information requests comprises additional context request(s). The additional context request may comprise a request for data representative of a current state of the task execution. For example, the process 500 may include transmitting additional context request(s) configured to prompt the user to provide real-time context data. In some embodiments, the additional context request may comprise a request updated visual input. Such updated visual input may be representative and/or indicative of a current state of task, target entity, and/or other entities depicted in the initial visual input (e.g., visual input received at step/operation 402).

In some examples, the addition context request may comprise a request for measurement data associated with the target entity or environment of the target entity. The AI task guidance system 106 may transmit one or more additional context requests over the AI-guided interactive task execution session, wherein each additional context request may be associated with a different timestamp within a time period defined by the AI-guided interactive task execution session. The additional context request(s) may be dynamically generated one or more times over the AI-guided interactive task execution session. For example, the AI task guidance system 106 may transmit additional context requests based on the progress of the task execution, user feedback, or current condition. Alternatively or additionally, the AI task guidance system 106 may transmit additional context requests in accordance with a pre-defined schedule.

In some embodiments, the one or more information requests comprises confirmation request(s) configured to confirm successful completion of various steps and/or actions specified in the task execution plan. For example, the AI task guidance system 106 may transmit confirmation requests at various stages during execution of the task to confirm successful completion of a step or action before moving on to a subsequent step or action. The confirmation request(s) may be dynamically generated one or more times over the AI-guided interactive task execution session. For example, the AI task guidance system 106 may transmit confirmation request(s) based on the progress of the task execution, user feedback, or current condition. Alternatively or additionally, the AI task guidance system 106 may transmit confirmation request(s) in accordance with a pre-defined schedule.

In some embodiment, the process 500 includes, at step/operation 506, receiving the user interaction data. For example, the AI task guidance system 106 may receive user interaction data from the user responsive to the information request(s). For example, the AI task guidance system 106 may receive, in real time, additional context data responsive to the additional context request(s), confirmation data responsive to the confirmation request(s), and/or user feedback representative and/or indicative of corrections or user-initiated adjustments.

The additional context data may comprise updated visual input as described above. The updated visual input may comprise captured images or videos that depict the target entity and/or other entities depicted in the initial visual input in their current state at the current stage of the task execution. In some embodiments, the depiction of the target entity and/or other entities in the updated visual input may include components of the target entity or other entities that were not visible in the initial visual input. For example, the updated visual input may depict internal component(s) of the target entity or other entities. In some embodiments, captured images or video may may capture component(s) of the target entity, which may not have been previously available or presented to the AI task guidance system 106

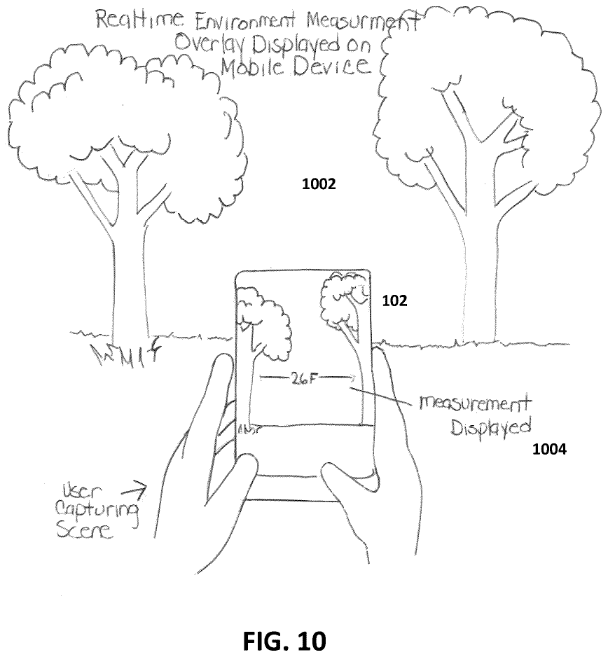

In some embodiments, the additional context data may comprise measurement data associated with the target entity, or other entities, or one or more components thereof. In some embodiments, the system 106 may obtain the measurement data based on the updated visual input. The AI task guidance system 106 may apply one or more image analysis algorithms to the visual input to determine the measurement data. In some embodiments, the AI task guidance system 106 may employ overlay techniques to obtain or determine the measurement data. For example, as shown in FIG. 10, the AI task guidance system 106 may direct the user to capture an environment 1002 associated with the target entity to enable real-time measurement determination via overlay display. As shown in FIG. 10, the measurement data 1004 may be rendered on the display of the user device.

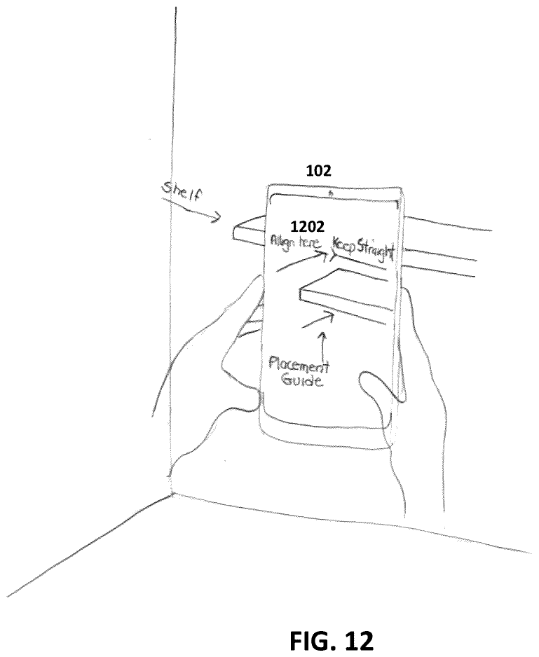

In some embodiments, one or more of the task instructions may take the form of a visual instruction overlay. By way of non-limiting example, as shown in FIG. 12, the AI task guidance system 106 may leverage such overlay techniques during task execution to provide guided instructions 1202 to the user such as the shelf placement instructions illustrated in FIG. 12. As described above, in some embodiments, the AI task guidance system 106 includes an augmented reality guidance module configured to perform and/or facilitate visual overlay operations that enable the AI task guidance system 106 to provide such visual overlay instructions, as shown in FIG. 12, For example, in some embodiments, the augmented reality guidance module may overlay visual execution cues onto a live camera view of the user device corresponding to at least on execution step to provide visual overlay instructions. In some embodiments, the augmented reality guidance module dynamically aligns the visual execution cues based on spatial features detected in the execution environment.

the AI task guidance system 106 includes an augmented reality guidance module configured to overlay visual execution cues onto a live camera view of the user device corresponding to at least on execution step, as shown in FIG. 12. In some embodiments, one or more components of the AI task guidance system 106 may include the augmented reality guidance module.

In some embodiments, the process 500 includes, at step/operation 508, fine-tuning the customized task execution plan based on the received user interaction data (e.g., additional context data, confirmation data, and/or user feedback including corrections or user-initiated adjustments). In some embodiments, fine-tuning the task execution plan comprises modifying one or more steps or task instructions based on the received user interaction data. For example, the AI task guidance system 106 may modify subsequent instructions based on the received user interaction data. In some embodiments, modifying subsequent instructions include, but not limited to, repeating or clarifying a step, adjusting step order (e.g., adjusting predefined sequence of steps), providing corrective guidance in response to detected errors identified based on the user interaction data, and/or escalating instruction detail when repeated failure is detected. The adaptive behavior of the AI task guidance system 106 enables the system to function as a closed-loop task completion assistant.

In some embodiments, the AI task guidance system 106 may generate updated workflows or sub-workflows based on the user interaction data. As described above, the customized task execution plan may be a dynamic task execution plan, wherein portions of the customized task execution plan may be generated or modified in real-time. In this regard, in some embodiments, fine-tuning the customized task execution plan may comprise generating additional instructions or modifying previous instructions. For example, additional video content or images depicting execution steps and task instructions may be generated based on received user interaction data. Alternatively or additionally, video content or images depicting execution steps and/or task instructions the stand/or existing video content and/or images may be modified or replaced based on the received user interaction data.

As described above, the AI task guidance system 106 may repeat one or more of the steps/operations of the process 500 until the task in determined to be complete, the user terminates the session, or a predefined completion condition is satisfied/met. In some embodiments, a completion status may be recorded for later retrieval or continuation.

In some examples, fine-tuning the task execution plan may include identifying an abnormal condition associated with the target entity or a component of the target entity based on the user interaction data, and generating a sub-workflow for correcting the abnormal condition. Such sub-workflow may comprise a sequence of one or more execution steps, wherein each step is associated with one or more actions (units of work) for corrective the abnormal condition. By way of example, the AI task guidance system 106 may determine that an abnormal condition associated with the target entity is due to an abnormal condition associated with a component of one or more of the components identified through the additional context data or other user interaction data received. The AI task guidance system 106 may then determine a sub-task based on the identified abnormal condition, and generate a sub-workflow for correcting the abnormal condition. The AI task guidance system 106 may decompose the sub-task into ordered sequence of execution steps in the same manner as described above with reference to step/operation 408, wherein each procedural step may be associated with one or more units of work (e.g., actions to be completed), relevant tools or materials, and/or preconditions or dependencies.

In some embodiments, the sub-workflow may take the form of a video content or image(s) that convey or otherwise present step-by-step instructions corresponding to the execution steps. In some embodiments, the sub-workflow may take the form of still image(s) that convey or otherwise present the step-by-step instructions. The video content and/or still image(s) may include audio that conveys the step-by-step instructions.

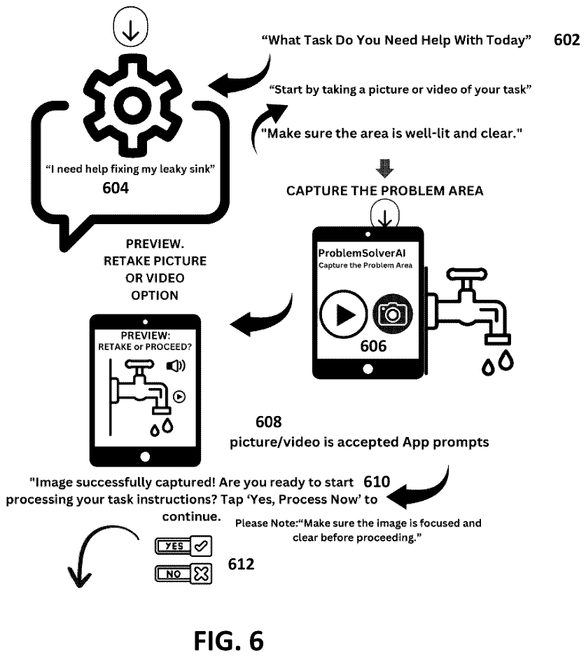

FIGS. 6-9D illustrate an operation example of intelligent task guidance process in accordance with at least some embodiments of the present disclosure. As shown in FIG. 6, the AI task guidance system 106 may receive a task guidance request 604. In the depicted example, the AI task guidance system 106 may receive the task guidance system responsive to a communication 602 from the AI task guidance system 106. The AI task guidance system 106 may direct the user to capture an image or video of the task (e.g. image or video of the target entity). The AI task guidance system 106 may render one or more user interface elements 606 on a display of the user device to facilitate the image or video capture. As shown in FIG. 6, the AI task guidance system 106 may optionally present a preview of the captured image or video of the target entity to the user. The AI task guidance system 106 may provide image/video capture confirmation 608 to the user indicating the captured image or video is accepted. The AI task guidance system 106 may transmit a confirmation request 610 for the AI task guidance system 106 to begin processing the task. The AI task guidance system 106 may render user interface selection element(s) 612 on the display of the user device to receive the user response to the confirmation request 610.

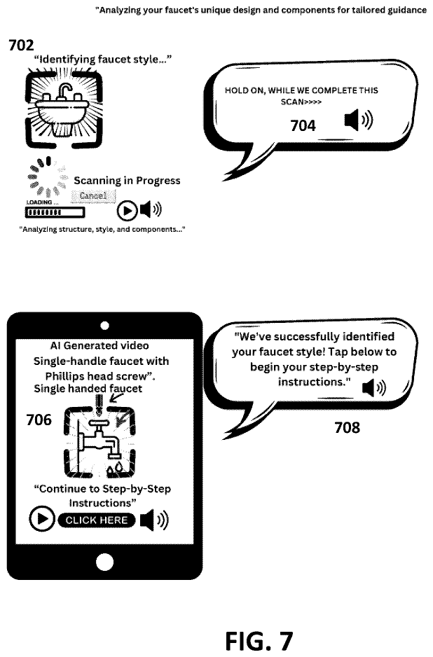

As shown in FIG. 7, the AI task guidance system 106 may process 702 the captured image or video of the target entity to identify entity data 706. The AI task guidance system 106 may transmit a messages (e.g., via voice message) that convey to the user the operation currently being performed by the AI task guidance system 106 or current status. For example, the AI task guidance system 106 may transmit a message 704 that conveys to the user that scanning operation is in progress. The AI task guidance system 106 may transmit a message 708 subsequent to determining the entity data. The message 708 may include a prompt/instruction that directs the user to navigate to a next stage in the process.

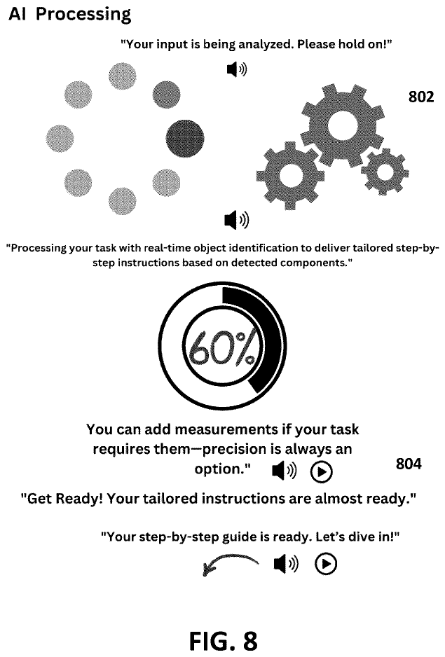

As shown in FIG. 8, the AI task guidance system 106 may transmit a message 802 notifying the user of the current operation being performed by the AI task guidance system 106. As further shown in FIG. 8, the AI task guidance system 106 may transmit a message 804 to the user that prompts the user to optionally provide measurement data.

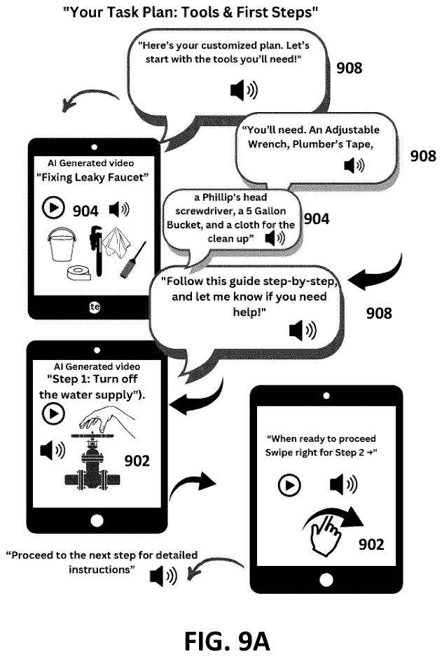

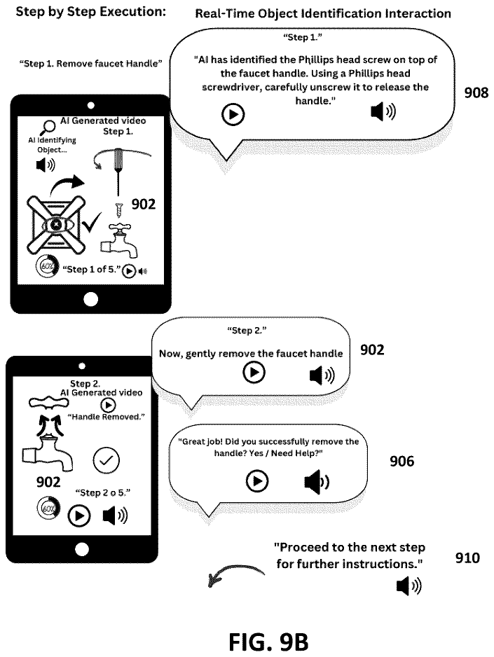

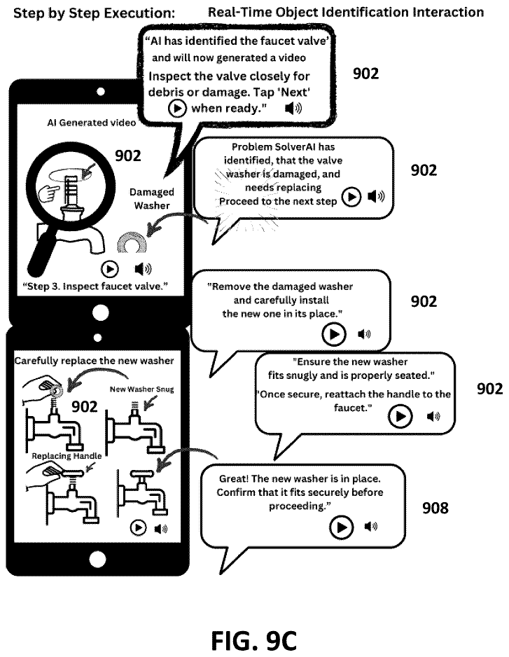

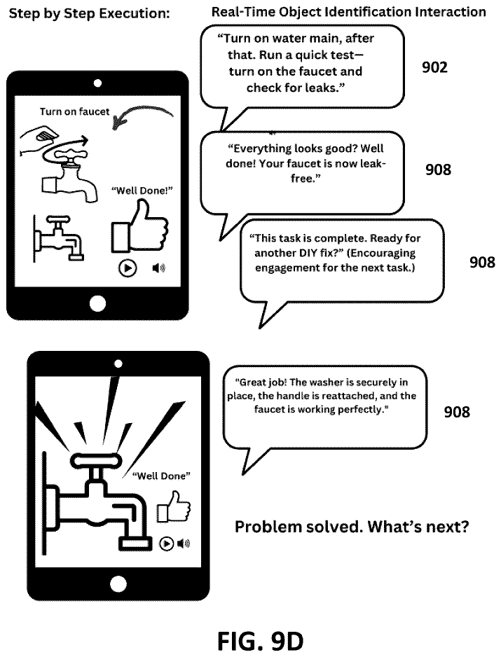

Referring now to FIGS. 9A-9D, the AI task guidance system 106 may generate a customized task execution plan as described above with reference to FIG. 4, and render the customized task execution plan on a display of the user device in accordance with a specified sequence. For example, the AI task guidance system 106 may render the steps 902 of the customized task execution plan, including recommended tools information 904 on the display of the user device in accordance with the specified sequence. The rendering of customized task execution plan (or portion thereof) may may initiate or otherwise trigger an AI-guided interactive task execution session, as described above.

As shown in FIGS. 9A-D, the AI-guided interactive execution session may involve multiple interactions between the user and the AI task guidance system 106, including the steps 902, confirmation requests 906, commentary 908, and navigation instructions 910 transmitted by the AI task guidance system 106.

As indicated above, in some embodiments, the AI task guidance system 106 may support projects or tasks that have not yet been initiated based on analysis of an existing physical environment and one or more user-defined project objectives. In such some embodiments, the AI task guidance system 106 may operate in a goal-driven mode rather than, for example, exclusively responding to an existing damage state or incomplete task. In such some embodiments, the AI task guidance system 106 enables the user to plan, visualize, and execute projects/tasks such as, for example, construction, assembly, or modification projects beginning from a baseline physical environment, prior to the commencement of physical work.

In such some embodiments, the AI task guidance system 106 may receive visual input depicting an existing physical environment, such as empty space, partially developed area, or unmodified structure. The AI task guidance system 106 may analyze the visual input to identify spatial characteristics of the environment; detect existing structures, surfaces, boundaries, or materials; and/or establish a baseline state from which a project may be initiated. The baseline environment analysis provides contextual grounding for subsequent task planning.

The AI task guidance system 106 may receive the one or more user-defined project objectives via a user device. Such user defined project objective may include, but not limited to a description of the intended structure, installation, or modification; functional goals, such as adding space, support, enclosure, or utility; or constraints related to materials, tools, time, or environment. In some embodiments, the user defined project objectives may be provide through text input, voice input, selection from predefined options, or combinations thereof.

Based on the analyzed baseline environment and user-defined project objectives, the AI task guidance system 106 may determine one or more tasks required to achieve the intended outcome. The AI task guidance system 106 may generate a sequence of tasks corresponding to a planned future state; decompose the sequence into ordered execution steps; and associate each step with required actions, tools, materials, or dependencies. Such task determination may be prospective, enabling planning prior to physical execution.

The AI task guidance system 106 may generate instructional guidance corresponding to the prospective tasks and execution steps. The guidance may include step-by-step procedural instructions; visual references indicating placement, orientation, or sequencing; and/or illustrative imagery or synthesized visual sequences representing intermediate or intended states. Such instructional guidance may be presented incrementally as the project progresses or reviewed in advance for planning purposes.

In some examples, the AI task guidance system 106 may transition from future-state planning to active task execution. Upon commencement of physical work, the AI task guidance system 106 may receive updated visual input reflecting changes to the environment; re-analyze the environment to confirm task progression; and/or adapt subsequent guidance based on actual execution. This enables continuity between planning and execution within a unified system. Non-limiting examples of such future-state planning application include construction of plant beds, gazebos, greenhouses, sheds, or similar structures; home additions or room modifications; installation of fixtures, enclosures, or support structures; multi-phase construction or assembly projects initiated from an unmodified environment. The future-state planning framework may operate as an alternative mode and may coexist with condition-driven task execution completion framework embodiments, as described herein. Both frameworks may share common system components.

### CONCLUSION

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A system comprising memory and one or more processors communicatively coupled to the memory, the one or more processors configured to:
receive, from a user device associated with a user, a task guidance request that identifies a task, wherein the task guidance request comprises one or more of natural language text, an image, or a video;
analyze the task guidance request to identify a task context comprising a task category, an execution environment, and a user skill level;
decompose the task into an ordered sequence of execution steps using a dynamic task decomposition algorithm that adapts step granularity based at least in part on the user skill level;
generate, for each execution step, instructional data comprising one or more actions;
generate a customized task execution plan by synthesizing a personalized instructional video sequence based on the ordered sequence of execution steps, wherein the personalized instructional video sequence depicts the ordered sequence of execution steps, and wherein synthesizing the personalized instructional video sequence comprises dynamically generating the personalized instructional video sequence; and
cause performance of the task based on the customized task execution plan.

2. The system of claim 1, wherein analyzing the task guidance request comprises fusing multimodal input data associated with the task guidance request into a unified task-state representation that informs subsequent instructional generation.

3. The system of claim 1, wherein the dynamic task decomposition algorithm is configured to adjust, based on prior task performance data associated with the user, one or more of (i) execution steps count, (ii) execution steps complexity, or (iii) execution steps sequence.

4. The system of claim 1, wherein synthesizing the personalized instructional video sequence comprises generating synthetic visual representations of task execution using an artificial intelligence video synthesis engine.

5. The system of claim 4, wherein the artificial intelligence video synthesis engine implements one or more of motion modeling, object interaction simulation, or procedural visualization to depict task execution.

6. The system of claim 1, wherein the personalized instructional video sequence comprises segmented steps that are individually pausable, replayable, or recordable based on user interaction during task execution.

7. The system of claim 1, wherein the one or more processors are further configured to:
receive progress data from the user device during task execution; and
modify subsequent instructional output in real time based on one or more of detected deviations, detected errors, or incomplete execution of one or more execution steps.

8. The system of claim 7, wherein the progress data comprises user-recorded video of task execution, and wherein the one or more processors are further configured to:
analyze the user-recorded video to identify errors relative to the ordered sequence of execution steps.

9. The system of claim 1, further comprising an augmented reality guidance module configured to overlay visual execution cues onto a live camera view of the user device corresponding to at least on execution step.

10. The system of claim 9, wherein the augmented reality guidance module dynamically aligns the visual execution cues based on spatial features detected in the execution environment.

11. The system of claim 1, wherein the instructional data further comprises dynamically generated tool and material recommendations based on one or more of the task context or execution environment.

12. The system of claim 1, further comprising a skill progression engine configured to:
track user task history; and
adjust future instructional generation based on accumulated skill data.

13. The system of claim 12, wherein the skill progression engine is configured to:
identify transferable skills across one or more task categories; and
modify instructional complexity based on the transferable skills.

14. The system of claim 12, wherein the instructional data further comprises safety-critical steps that are emphasized, reordered, or locked against skipping based on risk assessment associated with the task.

15. The system of claim 1, wherein the task comprises one of a home repair, appliance repair, automotive maintenance, craft assembly, accessibility assistance, or vocational training.

16. The system of claim 1, wherein the personalized instructional video sequence is generated uniquely for each user request and not reusable as a generic tutorial for multiple users.

17. The system of claim 1, wherein the personalized instructional video sequence is optimized for task completion validation.

18. A computer-implemented method comprising:
receiving, by one or more processors and from a user device, a task guidance request that identifies a task, wherein the task guidance request comprises one or more of natural language text, an image, or a video;
analyzing, by the one or more processors, the task guidance request to identify a task context comprising one or more of a task category, an execution environment, and a user skill level,
decomposing, by the one or more processors, the task into an ordered sequence of execution steps using a dynamic task decomposition algorithm that adapts step granularity based at least in part on the user skill level;
generating, by the one or more processors, for each execution step, instructional data comprising one or more actions;
generating, by the one or more processors, a customized task execution plan by synthesizing a personalized instructional video sequence based on the ordered sequence of execution steps, wherein the personalized instructional video sequence depicts the ordered sequence of execution steps, and wherein synthesizing the personalized instructional video sequence comprises dynamically generating the personalized instructional video sequence; and
causing, by the one or more processors, performance of the task based on the customized task execution plan.

19. The computer-implemented method of claim 18, wherein analyzing the task guidance request comprises fusing multimodal input data associated with the task guidance request into a unified task-state representation that informs subsequent instructional generation.

20. At least one non-transitory computer-readable storage medium having computer coded instructions configured to, when executed by at least one processor:
receive, from a user device, a task guidance request that identifies a task, wherein the task guidance request comprises one or more of natural language text, an image, or a video;
analyze the task guidance request to identify a task context comprising one or more of a task category, an execution environment, and a user skill level,
decompose the task into an ordered sequence of execution steps using a dynamic task decomposition algorithm that adapts step granularity based at least in part on the user skill level;
generate, for each execution step, instructional data comprising one or more actions;
generate a customized task execution plan by synthesizing a personalized instructional video sequence based on the ordered sequence of execution steps, wherein the personalized instructional video sequence depicts the ordered sequence of execution steps, and wherein synthesizing the personalized instructional video sequence comprises dynamically generating the personalized instructional video sequence; and
cause performance of the task based on the customized task execution plan.
